(19) United States
(12) Patent Application Publication
(10) Pub. No.: US 2011/0196571 A1
(43) Pub. Date: Aug. 11, 2011

(54) System And Method For The Collection And Monitoring Of Vehicle Data

(75) Inventors: Mark J. Foladare, East Brunswick, NJ (US); James A. Croley, San Ramon, CA (US); David Ohm, Commerce City, CO (US); Carl L. Nerup, Hawthorn Wood, IL (US); Waliur Rahman, Austin, TX (US); Satish Purushothaman, Wheeling, IL (US)

(73) Assignee: AT&T MOBILITY II LLC, Atlanta, GA (US)

(21) Appl. No.: 12/702,888

(22) Filed: Feb. 9, 2010

(51) Int. Cl. G08G 1/123; G06F 7/00; G01S 19/42

(52) U.S. Cl. 701/33; 340/989

(57) ABSTRACT

A communications hub for a vehicle includes a telematics device including a first communications interface to an external wireless network, a second communications interface to a plurality of vehicle sensors, and a global positioning system (GPS) interface. The telematics device is configured to (i) identify the driver of a vehicle; (ii) retrieve a profile for the driver including a profile permissions log; (iii) establish communications with the wireless network; (iv) establish communications with the vehicle sensor; (v) gather location information from the GPS interface; (v) collect data from a plurality of vehicle sensors; and (vi) send the collected data to an external recipient based on the profile permissions log.

### TECHNICAL FIELD

The technical field generally relates to telematics using wireless communications and more specifically is directed to telematics embedded in vehicles to provide value added services to subscribers and insurers.

### BACKGROUND

With ubiquitous cellular telephone coverage now the norm, and with the development of location tracking to offer location-based services, there are no telematics services which allow a person traveling in a vehicle to automatically collect location, driving information, and automobile diagnostic information and use that information to obtain more cost effective automobile insurance or to enable automobile insurance companies to better evaluate and manage the risk profiles of its customers. One prior art system is General Motors' OnStar system, which, according to its website, is an in-vehicle safety and security system which is intended to protect the drivers of a vehicle on the road. It's system offers 24-hour access to advisors for navigational purposes, a connection to emergency assistance, and access to hands-free calling using the OnStar system. OnStar also collects on-board diagnostic information and provides monthly emails to its subscribers, specifically tire pressure information, oil life indication, and mileage tracking for preventive maintenance reminders. OnStar also tracks mileage and through association with GMAC Insurance, offers discounts to drivers based on the amount of miles driven in the vehicle. Notwithstanding OnStar's suite of features, it does nothing to ensure that consumers and insurers are getting the best deal or that drivers are getting the necessary feedback to gain driving efficiencies.

### SUMMARY

The present invention is directed to a method for providing location control for a vehicle including the steps of defining a geographical region, collecting driving information relating to the location of a vehicle, comparing the location of a vehicle with the geographical region; and generating an alert if the location of a vehicle is not consistent with the parameters defined by the geographical region. The collecting step may be performed by a telematics device installed on a vehicle or by a mobile device. The geographical region may be defined as an allowable driving area or as a prohibited driving area and the method may also include the step of reporting the alert to a person other than the driver. The method may further include collecting additional driving information including vehicle operating conditions and defining acceptable parameters for the additional driving information and generating an alert if the additional driving information is inconsistent with the acceptable parameters.

The present invention is also directed to a system for controlling the location of a vehicle including a telematics unit within a vehicle configured to collect location data relating to the vehicle, a wireless telecommunications interface connected to the telematics unit, a network in communication with the wireless telecommunications interface, an element configured to receive permissible geographic area definitions, receive the vehicle location and compare it to the geographic area definition, and if the vehicle location is not within the permissible geographic area definitions, then to generate and send an alert. The system may further include a receiving terminal for receiving the alert.

According to another embodiment of the invention, a method of communicating from a vehicle includes identifying the driver of a vehicle, downloading a driver profile to a telematics device, collecting location and vehicle driving status information at the telematics device, and sending and receiving messages to and from a remote server based on one of the driver profile, the location and vehicle status information. The telematics device may communicate through a browser. The driver profile may include geographic restrictions and the messages include a comparison of the geographic restrictions and the vehicle location.

### BRIEF DESCRIPTION OF THE DRAWINGS

The following description is better understood when read in conjunction with the appended drawings.

FIG. 1 is an exemplary system that is configured for capturing and sharing telematics data in accordance with the present invention.

FIG. 2 is a block diagram showing the components of an ecosystem that forms an exemplary embodiment of the present invention.

FIG. 3 is a block diagram showing in more detail the components of an ecosystem forming an exemplary embodiment of the present invention.

FIG. 4 is a flow chart illustrating the method of collection and distribution of data according to one embodiment of the present invention.

FIG. 5 is a flow chart illustrating a method of collection and distribution of data according to another embodiment of the invention.

FIG. 6 is a table showing an example of a profile permissions log in accordance with an embodiment of the invention.

### DESCRIPTION OF ILLUSTRATIVE EMBODIMENTS

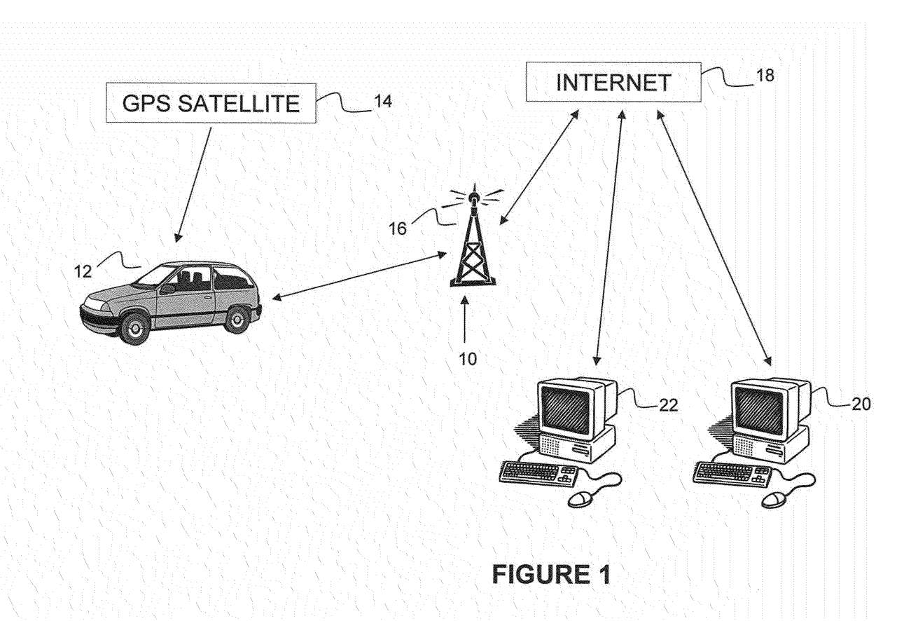

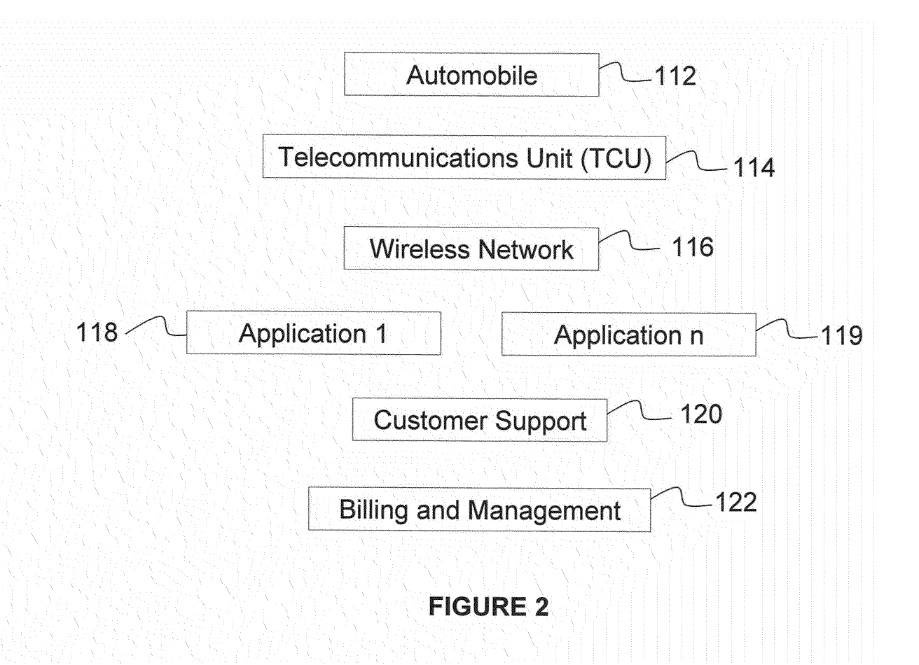

With reference to FIG. 1, there is shown the system 10 which may be constructed in an exemplary embodiment of the present invention. There is a vehicle 12 with a telecommunications unit device (shown as 114 in FIG. 2) within the vehicle 12. The vehicle receives location information from global positioning satellite (GPS) system 14. It should be understood by those skilled in the art, however, that other techniques for determining the location of the vehicle may be used, including but not limited to time-delay of arrival, assisted GPS, triangulation, and any other method now known or to be developed in the future. The telecommunications unit 114 communications in a bi-directional manner over the wireless network 16 which is in two-way communication with the network 18, which in a preferred embodiment, is the Internet. The wireless network 18 may be any type of cellular network, including but not limited to GSM, CDMA, WCDMA, 3GPP, Edge, 4G, or any other type of cellular network, and may also be any other type of wireless network, including WI-FI, WI-max, WLAN or any other type of wireless network capable of transmitting data. Attached to the network 18 are computer peripheral devices such as workstations 20, 22, it being understood by those skilled in the art that such peripheral devices may also include netbook computers, PDA's, internet-enabled mobile telephones, and any other peripheral device capable or sending or receiving data to and from the Internet.

A high level embodiment of the ecosystem of the present invention is illustrated in FIG. 2. The ecosystem may include the automobile 112 that is fitted with a telecommunications unit 114. The telecommunications unit 114 may be a port device that is plug compatible with the automobile's On-Board Diagnostic (OMB-II) port that is available on all cars from 1996 and newer. Typically, the OMB-II port is located on the driver's side of the passenger compartment near the center console. The port device preferable is universal in size such that one size fits all vehicles and is sized so as to be positioned covertly under the dash. Alternatively, the telecommunications unit 114 may be embedded in the vehicle at manufacture. A further alternative may be for a telecommunications unit 114 to be installed in the vehicle and tethered to a mobile unit such as a PDA or a mobile phone for connectivity.

Continuing with the ecosystem diagram of FIG. 2, there is shown a wireless network 116 which is of similar functionality as wireless network 16, including the various options of that network's protocol. Applications 118 and 119 are accessible to both the telecommunications unit 114 and the wireless network 116. Customer support 120 and billing and management functions 122 round out the ecosystem.

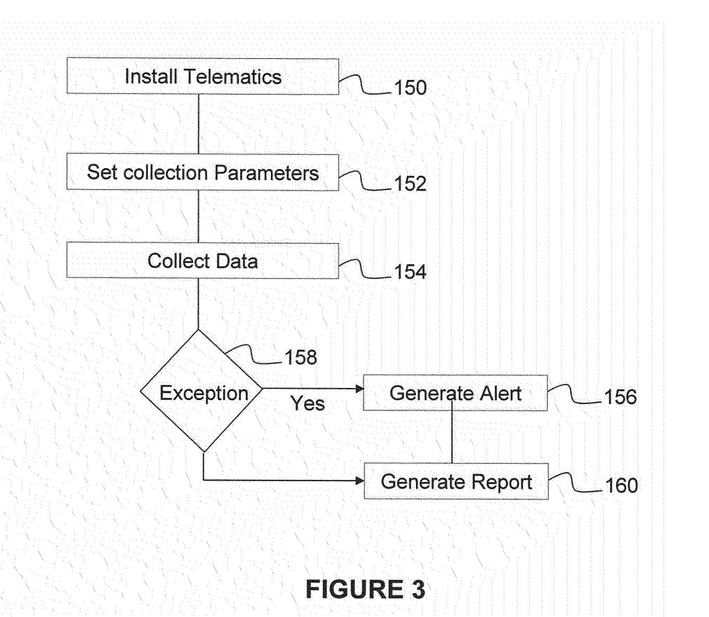

A more granular illustration of one embodiment of the ecosystem is shown in FIG. 3. In FIG. 3, the ecosystem is categorized in terms of voice services, consumer data services, and business-to-business data services. The support and management functionality is shown in block 322 and cuts across all three service descriptions. Applications are shown in block 306, and include searching, web browsing, traffic and other premium applications at block 314. Navigation, audio and video applications are shown at block 310 each of which forms part of the consumer data services applications. Diagnostics, insurance and safety applications are shown at block 308, each of which forms part of the business-to-business applications. Each of the applications in block 306 have access to the wireless connectivity shown in block 304 which interfaces to wireless network 18. The embedded telematics platform at block 302 incorporates the telecommunications unit 114 and any other peripheral devices forming the telematics platform and interfaces with the wireless connectivity 304. The telematics platform 302 collects vehicle performance and maintenance data directly or indirectly from the automotive original equipment manufacturer devices 300 embedded in the vehicle, for example, speed sensors, oxygen sensors, tire pressure sensors, and fault code readings, to name but a few. External antennas (not shown) or omni-antennas (not shown) encompassing the antenna functionality of the radio, GPS, cellular, WiFi, Bluetooth and the like may be included. The telematics platform 302 interfaces with the original equipment manufacturer of the vehicle, shown as block 300. The embedded telematics platform 302 may include blue tooth functionality, a user handset, and hands-free calling functionality, shown as blocks 316, 318, and 320, and preferably is powered by the vehicle power system with a battery backup. Memory is provided for storing and caching the collected data.

The telematics platform 302 preferably authenticates the driver of the vehicle. For example, the driver authentication may be performed using bio-metrics, i.e, fingerprint or other scans, user driving patterns, authentication using a key fob or chip, or parental controls. Once authenticated, the telematics platform 302 may retrieve a user profile, which may, for example, identify the driver (i) by name or other code, (ii) as a parent or child or authorized user, (iii) as a mechanic or service center or (iv) as an unauthorized users. The telematics platform 302 may further include a driver feedback mechanism which provides feedback to the driver based on the real-time or historical driving behavior of the driver. The feedback mechanism may, for example, include a light display such as red/yellow/green wherein the light color displayed corresponds to the target criteria based on actual performance and wherein red is unacceptable deviation, yellow is acceptable deviation but cautions the driver to improve, and green indicates acceptable driving behavior. The feedback mechanism may also include a heads-up display whereby the feedback is projected onto the drivers windshield or dash, a mobile phone message, an audio alert, or any combination of the foregoing.

In accordance with another embodiment of the invention, the telematics platform 302 may be configured to communicate through a browser loaded onto the telematics platform. Thus, operating in a client mode whereby data is communicated to and from the telematics device through a browser interface, the telematics platform is able to utilize data and applications that are resident on remote servers or in a cloud-computing configuration. The browser interface is configured to receive applications, requests for data, or for receiving data, and to send data wirelessly through the network to a remote server or remote servers within the network or connected to the network.

The telematics platform 302 may also be used as a communications platform with other applications and services connected through a network, which may, for example, include the internet. The telematics platform 302 may use the browser for coordinating such communications and may include social networking type of communications which may or may not be related to vehicles, driving, or insurance. The telematics platform 302 may also be used for remote communication and diagnostic services, providing remote technicians access to diagnostic codes, for example. The telematics device may also be used for interactive advertising based on data collected by the telematics device, including for example, receiving an advertisement via the telematics device based on the vehicle's location and fuel status. A user profile may be created which includes user preferences which the telematics platform 302 may retrieve from the driver authentication message which may control the type of messaging sent and received, including advertisements based on demographic data.

The ecosystem may be used to provide a variety of functions and services to users. For example, the ecosystem may be used to provide a variable rate insurance plan based on real-time driving behavior which is geared around objective, fair, and equitable insurance valuation criteria. The telematics platform 302 may collect data such as the driver identification, speed, tire pressure, gas volumes, odometer mileage, location, electronic systems information, breaking, acceleration, sensors, camera outputs, including video and still pictures, audio data including voice recordings, breath analysis, weather, traffic conditions, road conditions, and any other type of data that represents the driving habits of the driver, the operating condition and parameters of the vehicle, and the environment in which the vehicle is operating. The data may be collected in real time and stored until it is uploaded from the vehicle 12 through the wireless network 16 to the network 18 for downloading at workstations 20, 22. The data may be uploaded intermittently, either upon start-up of the engine, shut down of the engine, at specific time intervals, at specific mileage intervals, at service shops, or on demand or internally or externally generated request. The data may be aggregated and assimilated with other data, either prior to uploading (i.e., with other driver data from that vehicle) or after uploading (i.e., with driver data from other vehicles).

For example, the ecosystem may authenticate a driver through bio-metrics, login credentials, a key fob or chip, or any other authentication method. The ecosystem may employ parental controls and user profiles for each driver, including user profiles of parents, children, valet parkers, and even thieves. The ecosystem may provide feedback to the driver in real-time, quasi-real time, or non-real time reports. The feedback may be in the form of a visual display, including a traditional display or a heads up display, a mobile phone message, or an audio alert.

In accordance with a preferred embodiment of the invention, the ecosystem may be used as a central communications platform for the vehicle and the occupants of the vehicle. Based at least in part on the premise that the vehicle location will generally be known through the GPS interface and that the browser interface, the ecosystem platform will allow vehicle to PDA or computer terminal communications through the internet or other external network communications, thereby enabling additional communications and communications services. For example, in addition to the geofence application, the parents of a young driver may impose other driving restrictions and set up notifications or alerts to measure compliance with such restrictions. Such a system would preferably based on permissions, and depending upon the permission level granted, the communications services would be available.

In an exemplary embodiment, the telematics device may be programmed to define a set of actors (defined as members of an access group) and the actions permitted by each subset of those actors. Specifically, permissions to send and receive particular information may include the approved access groups of individuals, including parents, teenage drivers, friends, advertisers, mechanics, insurance providers and the driver itself. Based on the permissions, access to the vehicle's location and car maintenance and driving parameters may be obtained. The permissions for each access group may include “always provide access”, “never provide access,” “provide access with request”, “provide access with consent” or any combination of the foregoing. Any of the data may also be tagged, for example, car maintenance records may be available to the parent and driver groups under the “always provide access” category and available to a mechanic under the “provide access with request” category.

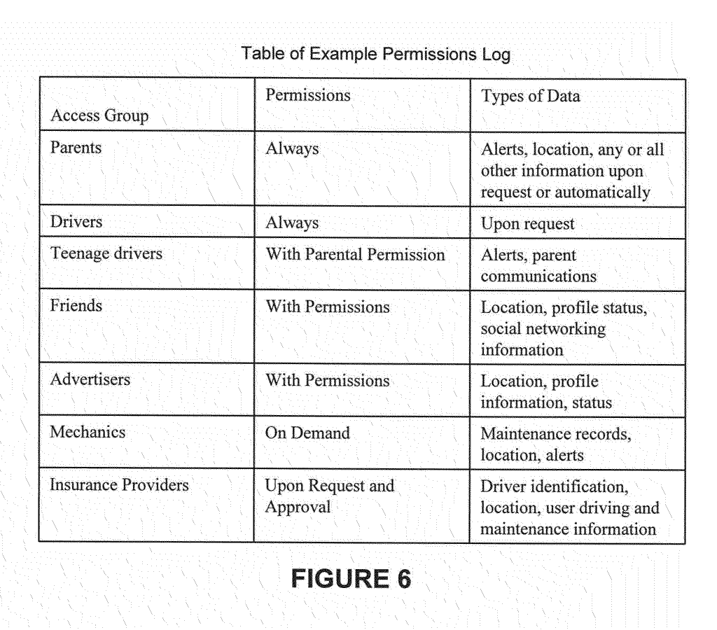

In operation, the telematics platform 302 may become the central communications hub of the vehicle for communicating with all vehicle systems and external computers and networks. The telematics platform 302 authenticates the driver and retrieves a driver profile. The driver profile preferably has a list of approved access groups of individuals and the accessibility category. The telematics platform may also access operating and maintenance parameters. The telematics platform 302 will collect and tag various types of data, including vehicle operating data, vehicle maintenance data, location data, and other types of data. The driver or passengers may also be able to enter or download personal data into the telematics device 302 for communication with others. The telematics device 302 may store the collected data locally or transmit the data to a remote server where it may be cached for future use. The data may be accessed by one or more of the approved access groups based on the permissions granted and the tags of the particular data. In an exemplary embodiment, a permissions log may be set up for each user profile. An exemplary and non-limiting profile permissions log is set forth in FIG. 6. It will be understood that not all groups need to be represented in a profile permissions log, and there may be additional user groups defined. There may also be other filters placed on the permissions log, including but not limited to, time of day communications, location specific communications, or priority messaging. All of the foregoing are within the scope of the present invention.

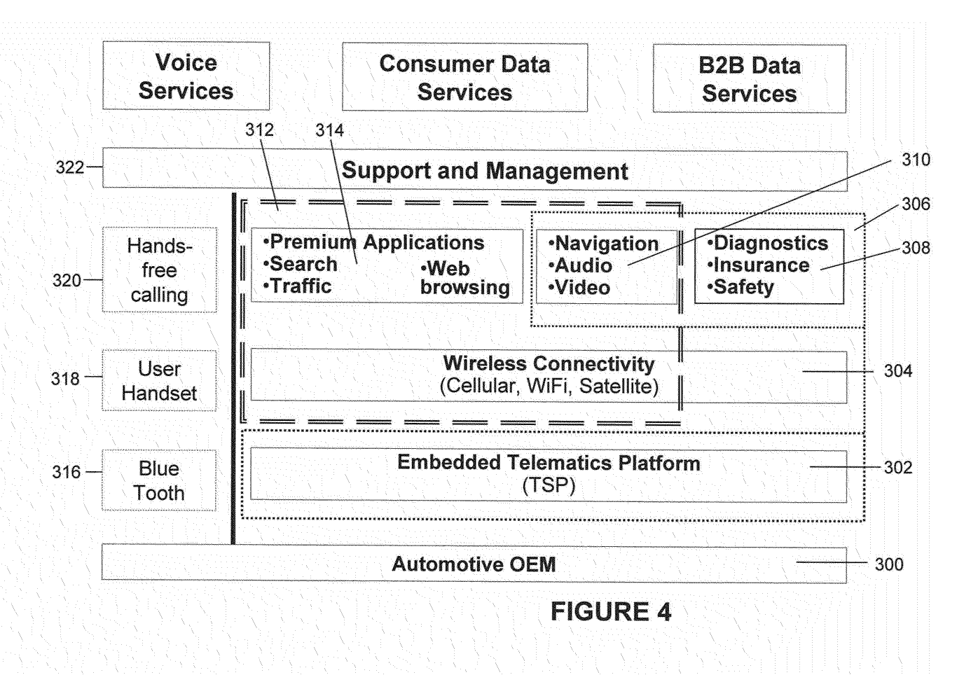

With reference to FIG. 4, there is shown a flow chart describing one embodiment of the method of the present invention involving setting up a geographic location wherein driving is permissible. At step 150, the telematics device is installed in the vehicle. The installation may be performed at the time of manufacture, may be installed after-market by a user through the OBD-II port, or it may be tethered to other mobile telecommunications equipment. At step 152, the data collection parameters are set, including the parameters for uploading the data. At step 154, the data is collected. At step 158, the decision is made as to whether the data collected comprises an exception to expected data. If yes, an alert is generated at 156 and is uploaded and sent to the insurance company using the wireless network 16 and the network 18. The alert may be in the form of a text message, an audio or visual message, or a telephone call, a page, or any other type of alerting message. The alert may be sent to the driver, the driver's parents, the insurer, the driver's employer, law enforcement, or any other member of an access group that has the requisite permissions and wants information relating to the driver's safety and/or driving parameters. Regardless of whether an exception has been detected, periodic reports may be generated at step 160.

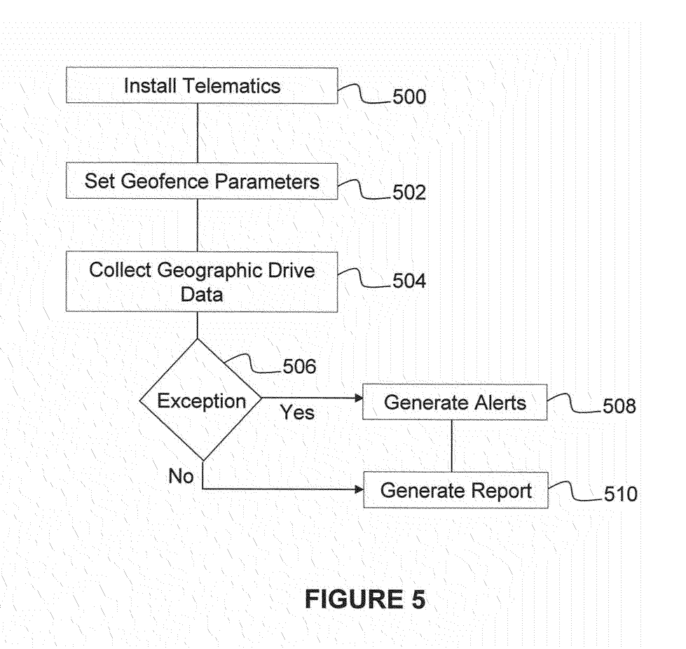

A more specific embodiment of this method is illustrated in FIG. 5 wherein there is shown a flow chart describing one embodiment of the method of the present invention. At step 500, the telematics device is installed in the vehicle. At step 502, the data collection parameters are set, more specifically, geofence parameters which define geographic areas in which the driver and/or vehicle are either permitted and not permitted. At step 504, the geographic drive data is collected. At step 506, the decision is made as to whether the data collected comprises an exception to geographic data. If yes, an alert is generated at 508 and is uploaded and sent using the wireless network 16 and the network 18. The alert may be in the form of a text message, an audio or visual message, or a telephone call, a page, or any other type of alerting message. The alert may be sent to the driver, the driver's parents, the insurer, the driver's employer, law enforcement, or any other entity that has an interest in the driver's safety and/or driving parameters. Regardless of whether an exception has been detected, periodic reports are generated at step 510. Using this method, the insurance company is able to retrieve accurate data relating to the driver's location and is able to bound its risk. For example, a vehicle's insurance may be voided if the insured is driving in a banned area. Likewise, an insured may agree to certain geographic restrictions in order to obtain reduced rates. Insurance companies may also be able to aggregate reported data in order to assess overall risk and set rates accordingly.

While the present invention has been described in connection with the various embodiments of the various figures, it is to be understood that other similar embodiments can be used or modifications and additions can be made to the described embodiment for performing the same function without deviating therefrom. For example, one skilled in the art will recognize that the definitions and scopes of mobile alerts as described in the present application may apply to any environment, whether wired or wireless, and may be applied to any number of such devices connected via a communications network and interacting across the network. Therefore, the method and system of defining mobile alerts should not be limited to any single embodiment, but rather should be construed in breadth and scope in accordance with the appended claims.

What is claimed:

1. A method for providing location control for a vehicle:
defining a geographical region;
collecting driving information relating to the location of a vehicle:
comparing the location of a vehicle with the geographical region; and
generating an alert if the location of a vehicle is not consistent with the parameters defined by the geographical region.

2. The method of claim 1 wherein the collecting step is performed by a telematics device installed on a vehicle.

3. The method of claim 1 wherein the collecting step is performed by a mobile device.

4. The method of claim 1 wherein geographical region is defined as an allowable driving area.

5. The method of claim 1 wherein the geographical region is defined as a prohibited driving area.

6. The method of claim 1 further comprising reporting the alert to a person other than the driver.

7. The method of claim 1 further comprising collecting additional driving information including vehicle operating conditions.

8. The method of claim 7 further comprising defining acceptable parameters for the additional driving information and generating an alert if the additional driving information is inconsistent with the acceptable parameters.

9. A system for controlling the location of a vehicle comprising:
a telematics unit within a vehicle configured to collect location data relating to the vehicle;
a wireless telecommunications interface connected to the telematics unit;
a network in communication with the wireless telecommunications interface;
an element configured to receive permissible geographic area definitions, receive the vehicle location and compare it to the geographic area definition, and if the vehicle location is not within the permissible geographic area definitions, then to generate and send an alert.

10. The system of claim 9 further comprising a receiving terminal for receiving the alert.

11. A method of communicating from a vehicle comprising: Identifying the driver of a vehicle;
Downloading a driver profile to the telematics device;
Collecting location and vehicle status information at the telematics device;
Sending and receiving messages to and from a remote server based on one of the driver profile, the location and vehicle status information.

12. The method of claim 11 wherein the telematics device communicates through a browser.

13. The method of claim 11 wherein the driver profile includes geographic restrictions and the messages include a comparison of the geographic restrictions and the vehicle location.

14. The method of claim 11 further comprising defining an access group and a set of permissions and tagging collected data, wherein the sending and receiving step is based on the access group, the permissions and the tagged data.

15. A communications hub for a vehicle, comprising a telematics device including a first communications interface to an external wireless network, a second communications interface to a plurality of vehicle sensors, and a global positioning system (GPS) interface, and wherein the telematics device is configured to (i) identify the driver of a vehicle; (ii) retrieve a profile for the driver including a profile permissions log; (iii) establish communications with the wireless network; (iv) establish communications with the vehicle sensor; (v) gather location information from the GPS interface; (v) collect data from a plurality of vehicle sensors; and (vi) send the collected data to an external recipient based on the profile permissions log.

16. The communications hub of claim 15 wherein the collected data is tagged according to a classification in the profile permissions log.

17. The communications hub of claim 15 wherein the telematics device is configured for communicating with the wireless network using a browser.

18. The communications hub of claim 17 wherein the telematics device has access to data storage elements through the wireless network.

19. The communications hub of claim 15 wherein the telematics device is further configured to generate an alert based on a comparison of vehicle sensor data to predetermined criteria.

20. The communications hub of claim 19 wherein the predetermined area is a geographical boundary and the comparison is based on the location of the vehicle.
